(19) United States
(12) Patent Application Publication
(10) Pub. No.: US 2026/0276877 A1
(43) Pub. Date: Sep. 17, 2026

(54) LIGHT DIFFUSION DEVICE

(71) Applicant: FURUKAWA ELECTRIC CO., LTD., Tokyo (JP)

(72) Inventors: Hideaki HASEGAWA, Tokyo (JP); Keisuke TAKE, Tokyo (JP); Masaki IWAMA, Tokyo (JP); Junichi HASEGAWA, Tokyo (JP)

(73) Assignee: FURUKAWA ELECTRIC CO., LTD., Tokyo (JP)

(21) Appl. No.: 19/166,282

(22) PCT Filed: Mar. 27, 2024
(86) PCT No.: PCT/JP2024/012311

§ 371 Date: Sep. 17, 2025

(30) Foreign Application Priority Data
Mar. 28, 2023 (JP) 2023-051331

(51) Int. Cl. F21V 8/00

(52) U.S. Cl. CPC G02B 6/001

(57) ABSTRACT

Provided is a light diffusion device capable of uniformly emitting light without reducing the emission amount of light from a light emission part of an optical fiber. An optical fiber 10 comprises: a light transmission part 11 that transmits light incident from a base end part toward a tip part; and a light emission part 12 that is provided on the tip side and emits the light transmitted through the light transmission part 11 from an outer peripheral surface. The light emission part 12 is a part formed by exposing a core 10a at least partially in the circumferential direction on the tip side of the optical fiber 10, and in the axial direction on the tip side of the optical fiber 10. The outer diameter D of the core 10a in the light emission part 12 is formed smaller on the tip side than on the base end side of the light emission part 12.

### TECHNICAL FIELD

The present invention relates to a light diffusion device for use in a medical device.

### BACKGROUND ART

Examples of a light diffusion device that has been known in the art include one for use as a medical device that radiates a predetermined area of the human body with laser light. This light diffusion device includes an optical fiber that includes a core near the center of the optical fiber in a radial direction, and a cladding near the periphery of the core, and emits laser light incident through a proximal end portion of the optical fiber thereon from the peripheral surface of a portion of the optical fiber near the distal end thereof (see, for example, Patent Document 1). The optical fiber of the known light diffusion device includes a light transmitter that transmits laser light incident through the proximal end portion thereon, and a light emitter that emits the laser light transmitted through the light transmitter near the distal end.

### CITATION LIST

### Patent Document

Patent Document 1: Japanese Unexamined Patent Application (Translation of PCT Application), Publication No. 2012-506569

### DISCLOSURE OF THE INVENTION

### Problems to be Solved by the Invention

The known light diffusion device has its light emitter formed by removing a portion of the cladding near the distal end of the optical fiber and thus exposing a portion of the core. For this reason, the intensity of laser light emitted from the known light diffusion device varies between a portion of the light emitter through which the core is exposed and a portion of the light emitter coated with the cladding. This makes it difficult to uniformly emit laser light from the peripheral surface of the light emitter.

An object of the present invention is to provide a light diffusion device that can uniformly emit light without reducing the amount of light emitted from a light emitter of an optical fiber.

### Means for Solving the Problems

A light diffusion device according to the present invention is directed to a light diffusion device including: an optical fiber that includes a core near a center of the optical fiber in a radial direction; and a cladding near a periphery of the core. The light diffusion device emits light incident through a proximal end portion of the optical fiber from near a distal end of the optical fiber. The optical fiber includes a light transmitter that transmits the light incident through the proximal end portion of the optical fiber toward a distal end portion of the optical fiber, and a light emitter, provided near the distal end, that emits, from a peripheral surface of the light emitter, the light transmitted through the light transmitter. The light emitter is at least one portion, in a circumferential direction, of the optical fiber near the distal end of the optical fiber, and is a portion of the optical fiber through which the core is exposed over an entire axial length of the portion of the optical fiber near the distal end of the optical fiber. A portion of the core that corresponds to the light emitter has a diameter that is smaller near the distal end than near a proximal end of the optical fiber.

In the light diffusion device of the present invention, a distal end portion of the portion of the core that corresponds to the light emitter preferably has a diameter that is 75% or less of a size of the proximal end portion of the light emitter, where the size of the proximal end portion is 100%.

In the light diffusion device of the present invention, at least one portion of a peripheral surface of an exposed portion of the core preferably has a protruding/recessed portion having a height difference equal to or less than a magnitude of a wavelength of the light transmitted through the light transmitter.

In the light diffusion device of the present invention, the protruding/recessed portion preferably has a height difference that is greater near a distal end of the light emitter than near a proximal end of the light emitter.

In the light diffusion device of the present invention, a part of the core forming the light emitter is preferably separate from a part of the core forming the light transmitter, and is preferably connected to the part of the core forming the light transmitter.

In the light diffusion device of the present invention, the protruding/recessed portion is preferably formed on a portion of the light emitter in the circumferential direction.

In the light diffusion device of the present invention, a period of a protruding/recessed shape of the protruding/recessed portion is preferably equal to or less than the magnitude of the wavelength of the light transmitted through the light transmitter.

### Effects of the Invention

According to the present invention, laser light can be uniformly emitted without decreasing the amount of the light emitted from a light emitter of an optical fiber, and the amount of the laser light emitted from a distal end portion of the light emitter can be reduced. This enables efficient emission of the laser light from the light emitter.

### BRIEF DESCRIPTION OF THE DRAWINGS

FIG. 1 is a cross-sectional view of an essential portion of a light diffusion device according to a first embodiment of the present invention;

FIG. 2 is a cross-sectional view of an essential portion of a light diffusion device according to a second embodiment of the present invention;

FIG. 3 is a cross-sectional view of an essential portion of a light diffusion device according to a third embodiment of the present invention; and

FIG. 4 is a cross-sectional view of an essential portion of a light diffusion device according to a fourth embodiment of the present invention.

### PREFERRED MODE FOR CARRYING OUT THE INVENTION

### First Embodiment

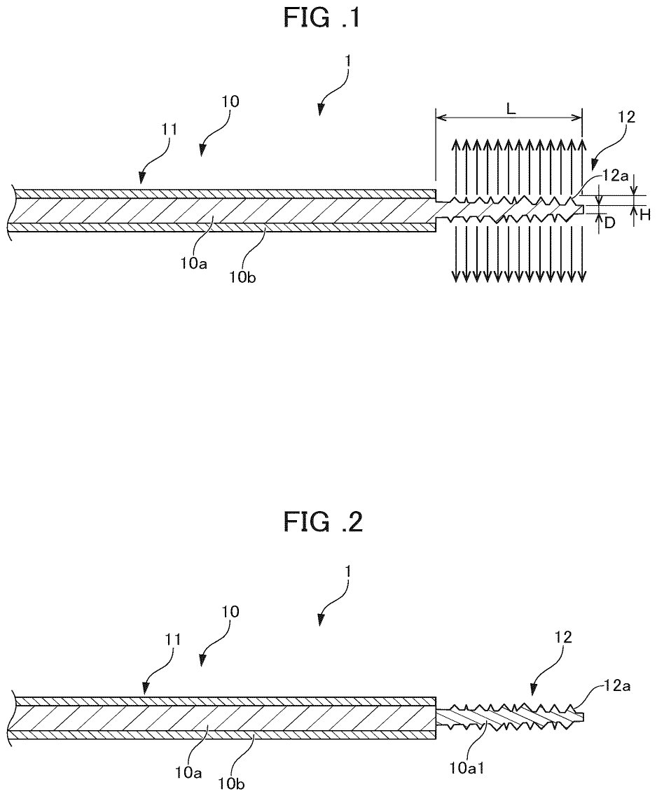

FIG. 1 illustrates a first embodiment of the present invention, and is a cross-sectional view of an essential portion of a light diffusion device.

A light diffusion device 1 of this embodiment is for use in, for example, photoimmunotherapy, which is one of therapeutic methods for cancer. In the photoimmunotherapy, a medicine containing antibodies to be combined with cancer cells and a substance responsive to light is administered to the human body, and the medicine combined with the cancer cells is irradiated with laser light to destroy the cancer cells, thereby treating the cancer.

The light diffusion device 1 includes a laser oscillator (not shown) for generating laser light, and an optical fiber 10 through which the laser light generated by the laser oscillator is transmitted, as illustrated in FIG. 1.

The laser oscillator includes a semiconductor laser. Passing electricity through the semiconductor laser allows laser oscillation to occur, thus generating laser light. The laser oscillator generates laser light having a wavelength from 400 nm to 800 nm.

The optical fiber 10 is, for example, an optical fiber made of silica glass, and includes a core 10a near the center thereof in a radial direction, and a cladding 10b near the periphery of the core 10a, as illustrated in FIG. 1. The distal end surface of the optical fiber 10 forms an angle from 7 degrees to 45 degrees with respect to the plane orthogonal to the axial direction of the optical fiber 10.

The relative refractive index difference between the core 10a and the cladding 10b of the optical fiber 10 is equal to or greater than 2% and equal to or less than 11%. The optical fiber 10 has a diameter of 500 μm, the core 10a has a diameter of 480 μm, and the cladding 10b has a thickness of 10 μm, for example. The cladding 10b of the optical fiber 10 preferably has an outside diameter equal to or greater than 102 μm and equal to or less than 1100 μm, the core 10 preferably has a diameter equal to or greater than 100 μm and equal to or less than 1000 μm, and the cladding 10b preferably has a thickness greater than or equal to 1 μm and equal to or less than 50 μm.

The optical fiber 10 includes a light transmitter 11 that transmits laser light incident through a proximal end portion thereof toward the distal end thereof, and a light emitter 12 provided near the distal end thereof to emit the laser light transmitted through the light transmitter 11 from the peripheral surface thereof.

The light emitter 12 has a length L from the distal end of the optical fiber 10 within the range from 10 mm to 100 mm, for example. The light emitter 12 is at least one portion, in the circumferential direction, of the optical fiber 10 near the distal end of the optical fiber 10, and is a portion of the optical fiber 10 through which the core 10a is exposed by removing a portion of the cladding 10b near the distal end of the optical fiber 10 over the entire axial length of the light emitter 12. In this embodiment, the core 10a is exposed by removing a portion of the cladding 10b near the distal end of the optical fiber 10b over the entire circumferential length of the cladding 10b.

At least one portion of the peripheral surface of the exposed portion of the core 10a has a protruding/recessed portion 12a having a height difference H equal to or less than the magnitude of the wavelength of the laser light transmitted through the light transmitter 11. In this embodiment, the protruding/recessed portion 12a is formed over the entire surface of the exposed portion of the core 10a.

The protruding/recessed portion 12a is formed through etching on the peripheral surface of the core 10a, for example. The height difference H between the peaks and valleys of the protruding/recessed portion 12a falls within, for example, the range in which the protruding/recessed portion 12a has an arithmetic mean roughness (Ra) of at least 0.01 μm and which is from 0.1 times to one time the magnitude of the wavelength of the laser light transmitted through the light transmitter 11. The peak-to-valley period of the protruding/recessed shape of the protruding/recessed portion 12a is equal to or less than the magnitude of the wavelength of the laser light transmitted through the light transmitter 11.

The protruding/recessed portion 12a has a height difference H that is greater near the distal end of the light emitter 12 than near the proximal end of the light emitter 12. In contrast, a portion of the core 10a corresponding to the light emitter 12 and excluding the protruding/recessed portion 12a has a diameter D that is less near the distal end of the light emitter 12 than near the proximal end of the light emitter 12. In this embodiment, the height difference H of the protruding/recessed portion 12a increases from the proximal end portion toward a distal end portion of the light emitter 12, and the diameter D of the portion of the core 10a corresponding to the light emitter 12 and excluding the protruding/recessed portion 12a decreases gradually from the proximal end portion toward the distal end portion of the light emitter. The diameter D of the portion of the core 10a corresponding to the light emitter 12 and excluding the protruding/recessed portion 12a decreases gradually to 75% from the proximal end portion toward the distal end portion of the light emitter 12, where the size of the proximal end portion is 100%.

In a case where the light diffusion device 1 configured as described above is used for photoimmunotherapy, the light diffusion device 1 radiates a medicine that has reached cancer cells with laser light with the distal end of the optical fiber 10 inserted into the human body.

The laser light generated by the laser oscillator is transmitted through the light transmitter 11 of the optical fiber 10, and is emitted from the light emitter 12 located near the distal end of the optical fiber 10.

At this time, the light emitter 12, which is configured as an exposed portion of the core 10a, can uniformly emit laser light from the entire peripheral surface of the exposed portion of the core 10a. The light emitter 12, which is configured as an exposed portion of the core 10a, can emit laser light with the required power even if the protruding/recessed portion 12a thereof has a height difference H that is smaller than that of a light emitter including a cladding. In addition, the protruding/recessed portion 12a having a height difference H that is smaller than that of the light emitter including the cladding reduces the area of the interface between the peripheral surface of a portion of the core 10a corresponding to the light emitter 12 and air. This can lower the thermal resistance at the interface, resulting in a reduction in the amount of heat generated. For example, in a case where a known light diffusion device including a light emitter with a cladding left makes the light emitter emit laser light at an input power of 800 mW, the temperature of the light emitter increases by 43° C. with respect to the room temperature. In contrast, in a case where the light diffusion device 1 of this embodiment makes its light emitter 12 emit laser light with an input power of 800 mW, the temperature of the light emitter 12 increases by 21° C. with respect to the room temperature. Exposing a portion of the core 10a in the light diffusion device 1 of this embodiment allows the amount of laser light emitted from the light emitter 12 to be equivalent to that from the known light diffusion device without roughening the light emitter of the known light diffusion device to a depth equal to or greater than the needed wavelength of the laser light.

The protruding/recessed portion 12a of the light emitter 12 has a height difference H that is larger near the distal end of the light emitter 12 than near the proximal end of the light emitter 12. This makes it easier for the light emitter 12 to emit laser light near the distal end thereof, thus allowing laser light to be more uniformly emitted from the entire axial length of the light emitter 12. In a case where the height difference H of the protruding/recessed portion 12a is uniform across the axial length of the light emitter 12, the amount of the laser light emitted near the distal end of the light emitter 12 is 50% of the amount of the laser light emitted near the proximal end of the light emitter 12. On the other hand, in a case where the height difference H of the protruding/recessed portion 12a is optimized to be larger near the distal end of the light emitter 12 than near the proximal end of the light emitter 12, the amount of the laser light emitted near the distal end of the light emitter 12 can be increased to about 98% of the amount of the laser light emitted near the proximal end of the light emitter 12.

In addition, the diameter D of the portion of the core 10a corresponding to the light emitter 12 and excluding the protruding/recessed portion 12a is smaller near the distal end of the light emitter 12 than near the proximal end of the light emitter 12, and decreases gradually to 75% from the proximal end portion toward the distal end portion of the light emitter 12, where the size of the proximal end portion is 100%. This can reduce the amount of laser light emitted from the distal end portion of the optical fiber 10 without reducing the amount of laser light emitted from the peripheral surface of a portion of the light emitter 12 near the distal end of the light emitter 12.

As can be seen, the light diffusion device of this embodiment is directed to the light diffusion device 1 including the optical fiber 10 that includes the core 10a near the center of the optical fiber 10 in the radial direction and the cladding 10b near the periphery of the core 10a. The light diffusion device 1 emits laser light incident through the proximal end of the optical fiber 10 from near the distal end of the optical fiber 10. The optical fiber 10 includes the light transmitter 11 through which light incident through the proximal end portion of the optical fiber 10 is transmitted toward the distal end portion of the optical fiber 10, and the light emitter 12 that emits the light transmitted through the light transmitter 11 from the peripheral surface of the light emitter 12. The light emitter 12 is at least one portion, in the circumferential direction, of the optical fiber 10 near the distal end of the optical fiber 10, and is a portion of the optical fiber 10 which is located near the distal end of the optical fiber 10 and through which the core 10a is exposed over the entire axial length of the light emitter 12. A portion of the core 10a corresponding to the light emitter 12 has a diameter D that is smaller near the distal end of the light emitter 12 than near the proximal end of the light emitter 12.

The diameter D of the portion of the core 10a corresponding to the light emitter 12 and excluding the protruding/recessed portion 12a is preferably 75% or less of the size of the proximal end portion, where the size of the proximal end portion of the light emitter 12 is 100%.

Thus, laser light can be uniformly emitted without reducing the amount of light emitted from the light emitter 12 of the optical fiber 10, and the amount of laser light emitted from the distal end portion of the light emitter 12 can be reduced. This enables efficient emission of laser light from the light emitter 12.

Here, the diameter D of a portion of the core 10a corresponding to the distal end portion of the light emitter 12 and excluding the protruding/recessed portion 12a is preferably 75% or more and 95% or less, more preferably 75% or more and 85% or less, of the diameter of the proximal end portion of the light emitter 12. In a case where the diameter D of the distal end portion of the light emitter 12 is greater than 95% of the diameter of the proximal end portion of the light emitter 12, the amount of laser light emitted from the peripheral surface of the core 10a decreases. This lowers the uniformity of the amount of laser light emitted from the light emitter 12 in the axial direction. In a case where the diameter D of the distal end portion of the light emitter 12 is less than 75% of the diameter of the proximal end portion, laser light is totally emitted near the proximal end of the light emitter 12 without reaching the distal end portion of the light emitter 12. This lowers the uniformity of the amount of laser light emitted from the light emitter 12 in the axial direction. As long as the required performance is satisfied, the diameter D of the portion of the core 10a corresponding to the light emitter 12 and excluding the protruding/recessed portion 12a may decrease gradually from the proximal end portion toward the distal end portion, may have an inflection point at which the diameter D increases partway, or may decrease in stages.

The at least one portion of the peripheral surface of the exposed portion of the core 10a preferably has the protruding/recessed portion 12a having a height difference equal to or less than the magnitude of the wavelength of the light transmitted through the light transmitter 11.

This can reduce the amount of heat generated by emitting the laser light without decreasing the amount of laser light emitted from the peripheral surface of a portion of the optical fiber 10 near the distal end thereof. Thus, the efficiency of treatment with photoimmunotherapy can be improved, and heat generated by the light emitter 12 can be kept from adversely affecting the human body.

The protruding/recessed portion 12a preferably has a height difference H that is greater near the distal end of the light emitter 12 than near the proximal end of the light emitter 12.

This makes it easier for the light emitter 12 to emit laser light near the distal end thereof, thus allowing laser light to be more uniformly emitted from the entire axial length of the light emitter 12.

The period of the protruding/recessed shape of the protruding/recessed portion 12a is preferably equal to or less than the magnitude of the wavelength of the laser light transmitted through the light transmitter 11.

This can increase the amount of emission from the light emitter 12.

### Second Embodiment

FIG. 2 illustrates a second embodiment of the present invention, and is a cross-sectional view of an essential portion of a light diffusion device. The same reference numerals are used to represent components equivalent to those of the foregoing embodiment.

The light diffusion device 1 of this embodiment includes a core 10a1 forming a light emitter 12, and a core 10a forming a light transmitter 11. The core 10a1 is separate from, and connected to, the core 10a forming the light transmitter 11.

Here, the core 10a and a cladding 10b forming the light transmitter 11 are made of silica glass. In contrast, the core 10a1 forming the light emitter 12 is made of a synthetic resin. The core 10a1 forming the light emitter 12 is connected to the core 10a forming the light transmitter 11 by caulking or any other process.

In the light diffusion device 1 configured as described above, the light emitter 12 located near the distal end of the optical fiber 10 is configured as a member made of a synthetic resin, and is thus highly flexible. This can reduce breakage.

As can be seen, just like the first embodiment, the light diffusion device of this embodiment can uniformly emit laser light without decreasing the amount of light emitted from the light emitter 12 of the optical fiber 10, and can reduce the amount of laser light emitted from the distal end portion of the light emitter 12. This enables efficient emission of laser light from the light emitter 12.

The core 10a1 forming the light emitter 12 is preferably separate from, and connected to, the core 10a forming the light transmitter 11.

Thus, a material that satisfies the required performance can be used for each of the light transmitter 11 and the light emitter 12. This can improve the performance of the light diffusion device.

### Third Embodiment

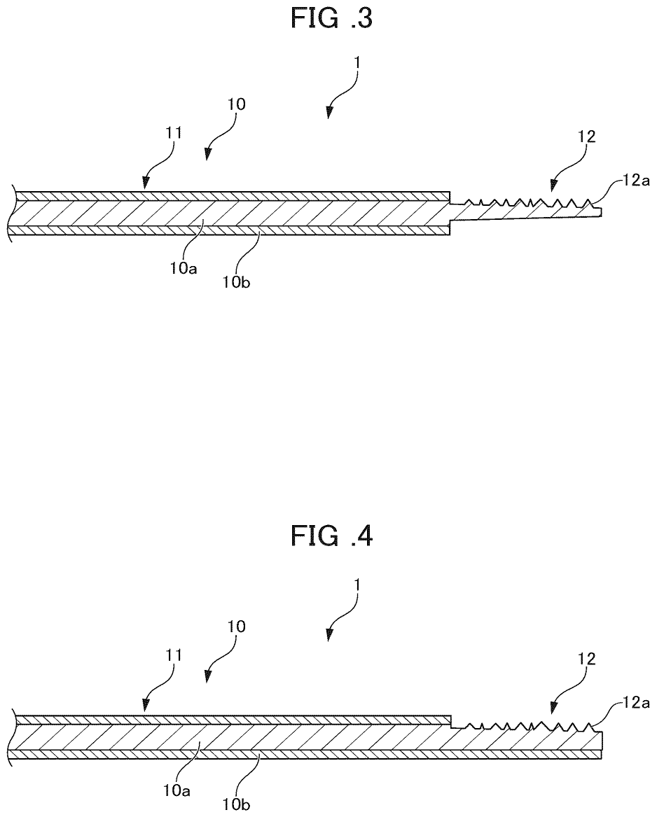

FIG. 3 illustrates a third embodiment of the present invention, and is a cross-sectional view of an essential portion of a light diffusion device. The same reference numerals are used to represent components equivalent to those of the foregoing embodiment.

The light diffusion device 1 of this embodiment includes a light emitter 12 formed over the entire circumferential length of a portion of the optical fiber 10 near the distal end thereof and over the entire axial length of the portion of the optical fiber 10 near the distal end thereof. The protruding/recessed portion 12a is formed on a portion, in the circumferential direction, of the core 10a corresponding to the light emitter 12.

In the light diffusion device 1 configured as described above, the protruding/recessed portion 12a is formed on the portion, in the circumferential direction, of the core 10a corresponding to the light emitter 12. This allows laser light to be emitted around a portion, in the circumferential direction, of the light emitter 12 having the protruding/recessed portion 12a.

As can be seen, just like the first embodiment, the light diffusion device of this embodiment can uniformly emit laser light without decreasing the amount of light emitted from the light emitter 12 of the optical fiber 10, and can reduce the amount of laser light emitted from the distal end portion of the light emitter 12. This enables efficient emission of laser light from the light emitter 12.

The protruding/recessed portion 12a is preferably formed on a portion of the light emitter 12 in the circumferential direction.

This enables emission of laser light around the portion, in the circumferential direction, of the light emitter 12 having the protruding/recessed portion 12a. Thus, a portion of the human body to be irradiated with laser light can be intensively irradiated with laser light.

### Fourth Embodiment

FIG. 4 illustrates a fourth embodiment of the present invention, and is a cross-sectional view of an essential portion of a light diffusion device. The same reference numerals are used to represent components equivalent to those of the foregoing embodiment.

The light diffusion device 1 of this embodiment includes a light emitter 12 formed on a portion, in the circumferential direction, of the optical fiber 10 near the distal end thereof and over the entire axial length of the portion of the optical fiber 10 near the distal end thereof. The protruding/recessed portion 12a is formed over the entire surface of the exposed portion of the core 10a.

In the light diffusion device 1 configured as described above, the light emitter 12 is configured as the portion, in the circumferential direction, of the optical fiber 10 near the distal end thereof. This allows laser light to be emitted from the portion, in the circumferential direction, of the optical fiber 10 near the distal end thereof. This enables emission of laser light from the light emitter 12 configured as the portion, in the circumferential direction, of the optical fiber 10 near the distal end thereof. Thus, a portion of the human body to be irradiated with laser light can be intensively irradiated with laser light.

As can be seen, just like the first embodiment, the light diffusion device of this embodiment can uniformly emit laser light without decreasing the amount of light emitted from the light emitter 12 of the optical fiber 10, and can reduce the amount of laser light emitted from the distal end portion of the light emitter 12. This enables efficient emission of laser light from the light emitter 12.

The foregoing embodiments show that the light transmitter 11 of the optical fiber 10 is configured as an optical fiber made of silica glass. However, this is merely an example. The optical fiber 10 may be made of silica glass or a synthetic resin such as acryl as long as it satisfies the required performance. The second embodiment shows the light emitter 12 that includes the core 10a made of a synthetic resin and that is connected to the light transmitter 11 configured as an optical fiber made of silica glass. However, this is merely an example. The light emitter may be configured as a core made of silica glass and connected to the light transmitter made of a synthetic resin as long as it satisfies the required performance.

The foregoing embodiments show photoimmunotherapy as an example of use of the light diffusion device. However, this is merely an example. The light diffusion device can be used for photodynamic therapy, catheter ablation therapy, and any other suitable therapy.

### EXPLANATION OF REFERENCE NUMERALS

1 Light Diffusion Device
10 Optical Fiber
10a, 10a1 Core
10b Cladding
11 Light Transmitter
12 Light Emitter
12a Protruding/Recessed Portion

1. A light diffusion device comprising:
an optical fiber that includes a core near a center of the optical fiber in a radial direction; and a cladding near a periphery of the core, the light diffusion device emitting light incident through a proximal end portion of the optical fiber from near a distal end of the optical fiber,
the optical fiber including a light transmitter that transmits the light incident through the proximal end portion of the optical fiber toward a distal end portion of the optical fiber, and a light emitter, provided near the distal end, that emits, from a peripheral surface of the light emitter, the light transmitted through the light transmitter,
the light emitter being at least one portion, in a circumferential direction, of the optical fiber near the distal end of the optical fiber, and being a portion of the optical fiber through which the core is exposed over an entire axial length of the portion of the optical fiber near the distal end of the optical fiber,
a portion of the core that corresponds to the light emitter having a diameter that is smaller near the distal end than near a proximal end of the optical fiber.

2. The light diffusion device of claim 1, wherein
a distal end portion of the portion of the core that corresponds to the light emitter has a diameter that is 75% or less of a size of the proximal end portion, where the size of the proximal end portion is 100%.

3. The light diffusion device of claim 1, wherein
at least one portion of a peripheral surface of an exposed portion of the core has a protruding/recessed portion having a height difference equal to or less than a magnitude of a wavelength of the light transmitted through the light transmitter.

4. The light diffusion device of claim 3, wherein
the protruding/recessed portion has a height difference that is greater near a distal end of the light emitter than near a proximal end of the light emitter.

5. The light diffusion device of claim 1, wherein
a part of the core forming the light emitter is separate from a part of the core forming the light transmitter, and is connected to the part of the core forming the light transmitter.

6. The light diffusion device of claim 3, wherein
the protruding/recessed portion is formed on a portion of the light emitter in the circumferential direction.

7. The light diffusion device of claim 3, wherein
a period of a protruding/recessed shape of the protruding/recessed portion is equal to or less than the magnitude of the wavelength of the light transmitted through the light transmitter.
